(19) United States
(12) Patent Application Publication
(10) Pub. No.: US 2014/0216589 A1
(43) Pub. Date: Aug. 7, 2014

(54) MULTIFUNCTIONAL ENERGY SAVING AND CARBON REDUCTION APPARATUS

(71) Applicants: Shoou-Jeng SONG, Taoyuan County (TW); Xiu-Hao LIU, Taichung City (TW)

(72) Inventors: Xiu-Hao LIU, Taichung City (TW); Shoou-Jeng SONG, Taoyuan County (TW); Tai-You WANG, Nantou County (TW)

(21) Appl. No.: 14/151,810

(22) Filed: Jan. 10, 2014

(30) Foreign Application Priority Data
Feb. 1, 2013 (TW) 102202246

(51) Int. Cl. F02M 27/06

(52) U.S. Cl. CPC F02M 27/065
USPC 138/109; 137/82

(57) ABSTRACT

A multifunctional energy saving and carbon reduction apparatus includes an outer pipe and a foam layer. The outer pipe includes an inlet and an outlet, and each of the inlet and outlet is connected to an outer-pipe connector, inside the outer pipe is formed an inner space in communication with the inlet and the outlet. The foam layer is stuffed in the inner space and formed with a plurality of orifices and contains small amount of natural radiation ore powder. The multifunctional energy saving and carbon reduction apparatus allows the reactants, such as liquid fuel and oxidizer or gaseous fuel and oxidizer, to come into direct contact with the radiation element layer, when the reactants flow through the energy saving and carbon reduction apparatus, so as to enhance combustion efficiency.

### BACKGROUND OF THE INVENTION

1. Field of the Invention

The present invention relates to a multifunctional energy saving and carbon reduction apparatus, and more particularly to a multifunctional energy saving and carbon reduction apparatus which is capable of better refining and atomizing the fuel and oxidizer, and enhancing combustion efficiency.

2. Description of the Prior Art

Referring to FIGS. 1 and 2, a conventional energy-saving and carbon reduction device, which is called far infrared enhancer, comprises an outer pipe 11, an inner fuel pipe 12, two outer covers 13 and a far infrared ceramic pipe 14. The two outer covers 13 are fixed at two ends of the outer pipe 11. The inner fuel pipe 12 is inserted in the outer pipe 11. Two ends of the inner fuel pipe 12 are exposed out of the two outer covers 13 and connected to fuel supply pipe of fuel supply system of the automobile. The far infrared ceramic pipe 14 is disposed between the outer pipe 11 and the inner fuel pipe 12. When reactants, such as gasoline, flows into the inner fuel pipe 12, the far infrared ceramic pipe 14 will produce far infrared rays to lengthen the molecular bond of the gasoline, so that the surface tension of the gasoline is reduced, and the gasoline droplets shrink and are atomized, thus enhancing the combustion efficiency of the engine.

Another conventional energy-saving and carbon reduction apparatus is called fuel activation apparatus, which comprises a plastic tubular base with a hole, a groove penetrates the hole, and a radiating element layer is formed on the inner surface of the hole.

It is to be noted that for all conventional energy saving and carbon reduction devices, the reactants flow directly within the inner fuel pipe 12. Namely, the reactants are separated by from coming into contact with the far infrared ceramic pipe 14 or radiating element layer. Therefore, there are few interactions between the reactants and the far infrared ceramic pipe 14 or the radiating element layer, and the combustion efficiency is still limited.

The present invention has arisen to mitigate and/or obviate the afore-described disadvantages.

### SUMMARY OF THE INVENTION

The primary objective of the present invention is to provide a multifunctional energy saving and carbon reduction apparatus which allows the reactants, such as liquid fuel and oxidizer or gaseous fuel and oxidizer, to come into direct contact with the radiation element layer, when the reactants flow through the energy saving and carbon reduction apparatus, so as to enhance combustion efficiency.

To achieve the above objective, a multifunctional energy saving and carbon reduction apparatus in accordance with the present invention comprises an outer pipe and a foam layer. The outer pipe includes an inlet and an outlet, and each of the inlet and outlet is connected to an outer-pipe connector, inside the outer pipe is formed an inner space in communication with the inlet and the outlet. The foam layer is stuffed in the inner space and formed with a plurality of orifices and contains small amount of natural radiation ore powder.

### BRIEF DESCRIPTION OF THE DRAWINGS

FIG. 1 is a longitudinal cross sectional view of a conventional energy saving and carbon reduction apparatus;

FIG. 2 is a transverse cross sectional view of the conventional energy saving and carbon reduction apparatus;

FIG. 3 is a longitudinal cross sectional view of a multifunctional energy saving and carbon reduction apparatus in accordance with the present invention;

FIG. 4 is a transverse cross sectional view of the multifunctional energy saving and carbon reduction apparatus in accordance with the present invention;

FIG. 5 is a cross sectional view of another embodiment of the multifunctional energy saving and carbon reduction apparatus in accordance with the present invention;

FIG. 6 is a longitudinal cross sectional view of another embodiment of the multifunctional energy saving and carbon reduction apparatus in accordance with the present invention; and

FIG. 7 shows that the multifunctional energy saving and carbon reduction apparatus in accordance with the present invention is installed on an external combustion engine.

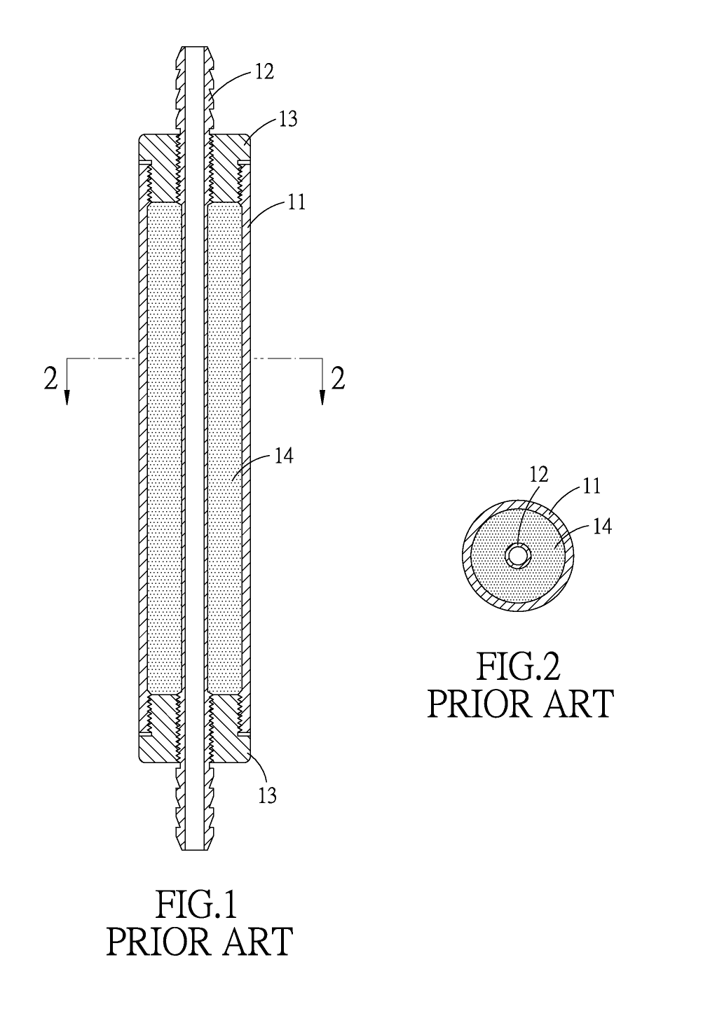

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

It is to be noted that, in the following descriptions, similar components are indicated with the same reference numbers.

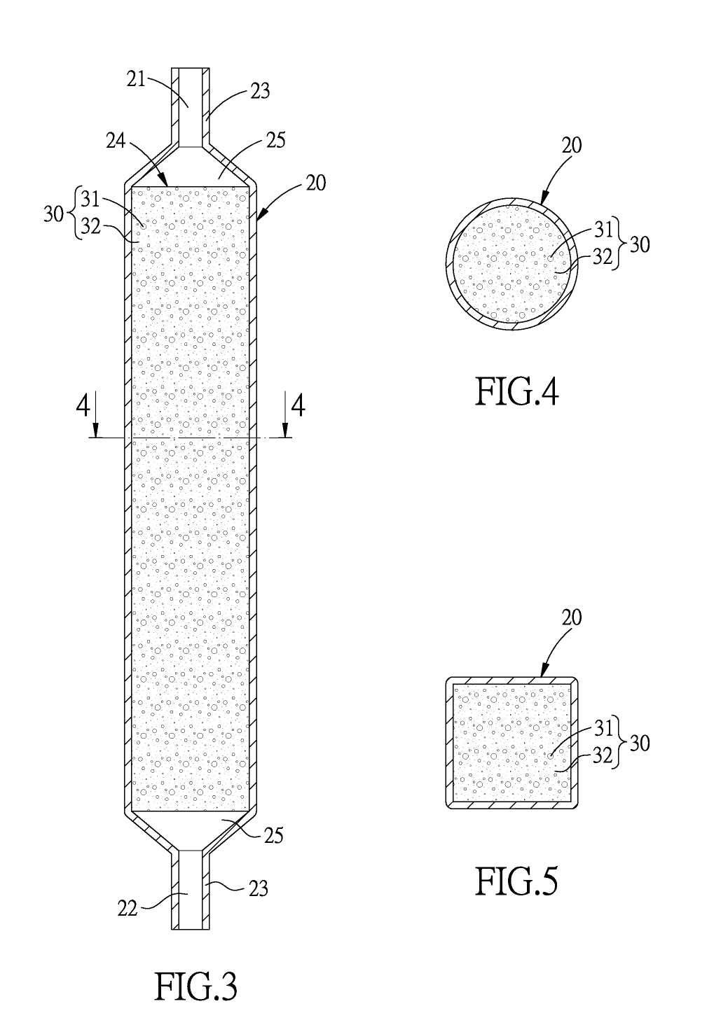

Referring to FIGS. 3 and 4, a multifunctional energy saving and carbon reduction apparatus in accordance with the present invention comprises: an outer pipe 20 and a foam layer 30. The energy saving and carbon reduction apparatus is designed for reactants to flow through. The reactants are liquid fuel and oxidizer or gaseous fuel and oxidizer.

The outer pipe 20 is made metal and circular, square or in any shapes in cross section. In this embodiment, the outer pipe 20 is circular-shaped in cross section and has an inlet 21 and an outlet 22, and each of the inlet 21 and outlet 22 is connected to an outer-pipe connector 23. Inside the outer pipe 20 is formed an inner space 24 in communication with the inlet 21 and the outlet 22.

The foam layer 30 is integrally stuffed in the inner space 24 or cut into pieces and then disposed in a spaced manner in the inner space 24 to form a beehive-like ceramic structure. The foam layer 30 is formed with a plurality of orifices 31 through which reactants can flow freely within the outer pipe 20. The foam layer 30 can be foamed by the mixture of the formulation of natural radiation ore powder and foam material, and then the foamed product is cut into desired shape. Or, after the foam layer 30 is formed, the inner and outer surfaces of the foam layer 30 can be coated with the mixture of the formulation of natural radiation ore powder and adhesive, so that the foam layer 30 contains small amount of natural radiation ore powder 32. The formulation of natural radiation ore powder 32 can contain tourmaline powder which produces far infrared and Anion, and natural ore which contains tiny amount of radiation elements. For example, the formulation of natural radiation ore powder 32 can be the mixture of Monazite, zircon powders. The foam layer 30 is coated with a safe amount of natural radiation ore powder, under the premise that the amount of the natural radiation ore powder does no harm to human health, so that the foam layer 30 contains small amount of natural radiation ore powder 32. Besides, with the properties of high density, large contact area, and high flow rate of the foam layer 30, the reactants (fuel) and the oxidizer can be better atomized and refined, and the intercalation between the reactants and the oxidizer can be enhanced, so as to considerably improve the combustion efficiency. Furthermore, between the foam layer 30 and the inlet and outlet 21, 22 is defined a steady-flow space 25, so that the flow rate and pressure drop can be controlled to a predetermined value when reactants flow into the energy saving and carbon reduction apparatus.

The outer pipe 20 serves as a safety protection and wraps around the foam layer 30 to prevent excessive amount of radiation leakage.

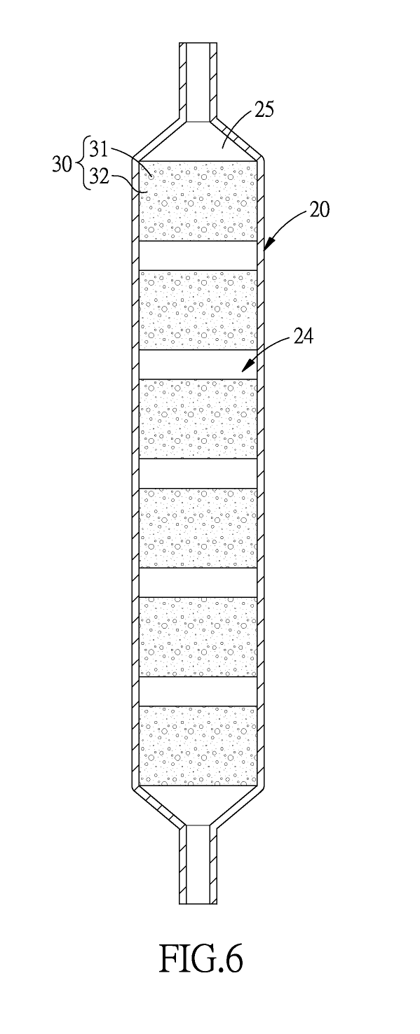

The outer pipe 20 and the foam layer 30 can have different shapes for different applications. For example, as shown in FIG. 5, the outer pipe 20 in accordance with another embodiment of the present invention has a square cross section, and as shown in FIG. 6, the foam layer 30 is cut into several sections which are then disposed in a spaced manner in the inner space 24, so as to buffer the flow of reactants within the inner space 24, and the flow rate and pressure drop can be controlled to a predetermined value.

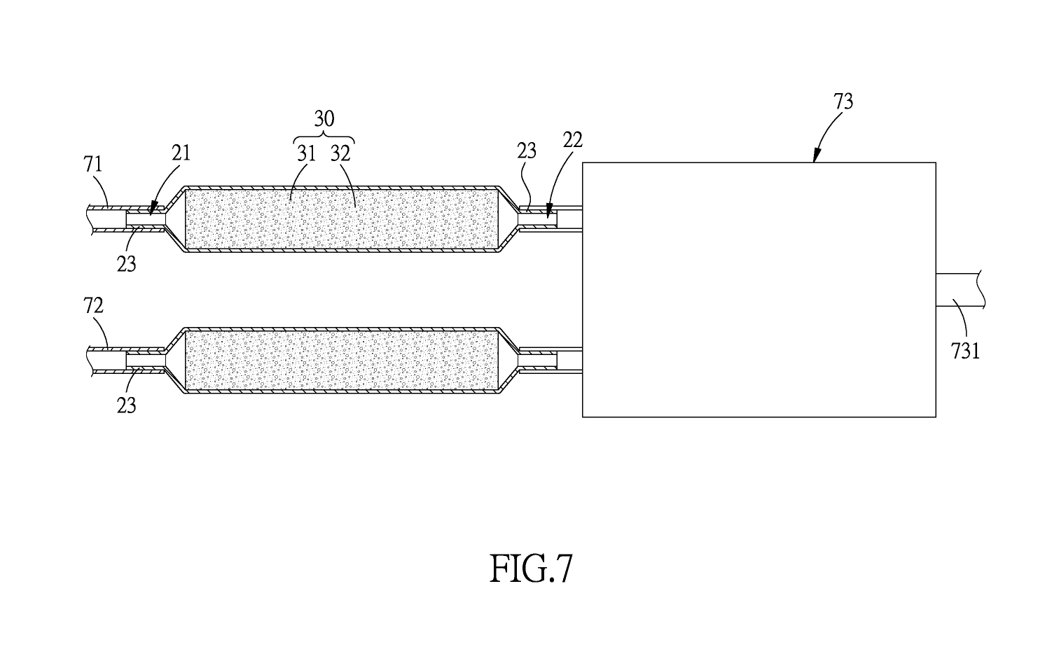

What mentioned above are the structural relations of the components of the preferred embodiment of the present invention, for a better understanding of the invention, its operating advantages and the specific objects attained by its uses, reference should be had to the following description and. FIG. 7. The outer-pipe connectors 23 of the inlet 21 are connected to a fuel pipe 71 and an oxidizer pipe 72, respectively. Reactants flow through the orifices 31 within the foam layer 30 to react with the natural radiation ore powder 32 in the foam layer 30, and then flow out of the outlet 22. When reacting with the natural radiation ore powder 32, the reactants (fuel) can be better atomized and refined, and the ionization energy of the oxidizer can be effectively reduced. Meanwhile, the surface tension of the fuel reduces, and the fuel droplets shrink for easy atomization, so as to increase the contact area with air, enhancing combustion efficiency. After the reactants within the fuel pipe 71 and the oxidizer pipe 72 react with the natural radiation ore powder 32 in the foam layer 30, the reactants will be blended and combusted in the combustion chamber 73, and combustion products will be discharged out of the combustion chamber 73 via a discharge port 731.

The multifunction of the present invention means that the foam layer can be made into different shapes and made of different materials which have different foam characteristics, densities, temperature resistance characteristics, and then the foam layer can be used in various internal or external combustion engines. In addition, if the foam layer 30 containing natural radiation ore powder is made of high temperature resistant material, it can also be used as a heat exchange system to heat the cold air by recovering the waste heat produced after the reaction between the fuel and oxidizer, thus further enhancing combustion efficiency.

In general, the present invention processes the following properties:

Multifunction: the energy saving and carbon reduction apparatus in accordance with the present invention can enhance combustion efficiency when it is installed on the fuel (liquid or gaseous) and oxidizer pipelines of any internal or external combustion engines. The materials of the foam layer, and the size, density, flow rate, shape, and the formulation of natural radiation ore powder can be determined by the size and purpose of the combustion apparatus. In addition, the energy saving and carbon reduction apparatus of the present invention can also be used as a heat exchange system to heat the cold air by recovering the waste heat produced after the reaction between the fuel and oxidizer, thus further enhancing combustion efficiency.

Low cost: the foam material is very cheap, with appropriate processing, it can be used for various energy saving and carbon reduction purpose both in industrial and livehood fields.

High safety: tiny amount of radiation core is coated on a large area of the foam layer, so that the amount of radiation is controlled to a very safe level. The natural radiation ore powder is glued to the foam layer by adhesive, so as to prevent the radiation powder from being released into atmosphere. Besides, the outer pipe which is made of metal serves as a safety protection and wraps around the foam layer to prevent excessive amount of radiation leakage.

While we have shown and described various embodiments in accordance with the present invention, it is clear to those skilled in the art that further embodiments may be made without departing from the scope of the present invention.

What is claimed is:

1. A multifunctional energy saving and carbon reduction apparatus comprising:
an outer pipe with an inlet and an outlet, and each of the inlet and outlet being connected to an outer-pipe connector, inside the outer pipe being formed an inner space in communication with the inlet and the outlet; and
a foam layer stuffed in the inner space and formed with a plurality of orifices and containing small amount of natural radiation ore powder.

2. The multifunctional energy saving and carbon reduction apparatus as claimed in claim 1, wherein the outer pipe is circular in cross section.

3. The multifunctional energy saving and carbon reduction apparatus as claimed in claim 1, wherein the outer pipe is square-shaped in cross section.

4. The multifunctional energy saving and carbon reduction apparatus as claimed in claim 1, wherein flow rate and pressure drop of reactants are controlled to a predetermined value when reactants flow into the energy saving and carbon reduction apparatus.
